(19) United States
(12) Patent Application Publication
(10) Pub. No.: US 2021/0281821 A1
(43) Pub. Date: Sep. 9, 2021

(54) RECORDING AND DISPLAY OF LIGHT FIELDS

(71) Applicant: Hewlett-Packard Development Company, L.P., Spring, TX (US)

(72) Inventors: Diogo Lima, Palo Alto, CA (US); Alexei Saltanov, Palo Alto, CA (US); Carlos Haas, Palo Alto, CA (US)

(21) Appl. No.: 16/482,305

(22) PCT Filed: Jul. 21, 2017
(86) PCT No.: PCT/US2017/043339

§ 371 Date: Jul. 31, 2019

(51) Int. Cl. H04N 13/327; H04N 13/302; H04N 13/324

(52) U.S. Cl. CPC H04N 13/327; H04N 13/324; H04N 13/302

(57) ABSTRACT

Recording and display of light fields is disclosed. An example apparatus includes a mapper to transform a first image into a second image based on a first map, a display device to output the second image as a first optical output, and a first optical member to pseudo-randomly distort at least a first portion of the first optical output to form a first light field.

### BACKGROUND

Three-dimensional (3D) stereoscopic images can be formed by displaying two different images, one for each of a user's eyes. When the two images represent different views of a scene, object, etc. taken from different viewpoints, the images collectively represent a stereoscopic 3D image of the scene, object, etc. A light field includes a plurality of light rays travelling in a plurality of directions in a region in space. A light field may be considered to be four-dimensional (4D), because points in three-dimensional space have an associated direction.

### BRIEF DESCRIPTION OF THE DRAWINGS

FIG. 1 is a block diagram of an example light field recording apparatus for recording images of light fields, according to this disclosure.

FIG. 2 is a block diagram of an example playback apparatus for displaying light fields, according to this disclosure.

FIG. 3 illustrates an example system for training an apparatus for displaying light fields, according to this disclosure.

FIG. 4 is a block diagram illustrating an example implementation of the example map determiner of FIG. 3.

FIG. 5 is a flowchart representation of example computer-readable instructions that may be executed to implement the example map determiner of FIG. 3 and/or FIG. 4 to train a playback apparatus.

FIG. 6 illustrates an example processor platform structured to execute the example computer-readable instructions of FIG. 5 to implement the example map determiner of FIG. 3 and/or FIG. 4.

Wherever possible, the same reference numbers will be used throughout the drawing(s) and accompanying written description to refer to the same or like parts. Connecting lines or connectors shown in the various figures presented are intended to represent example functional relationships and/or physical or logical couplings between the corresponding elements.

### DETAILED DESCRIPTION

Reference will now be made in detail to non-limiting examples of this disclosure, examples of which are illustrated in the accompanying drawings. The examples are described below by referring to the drawings.

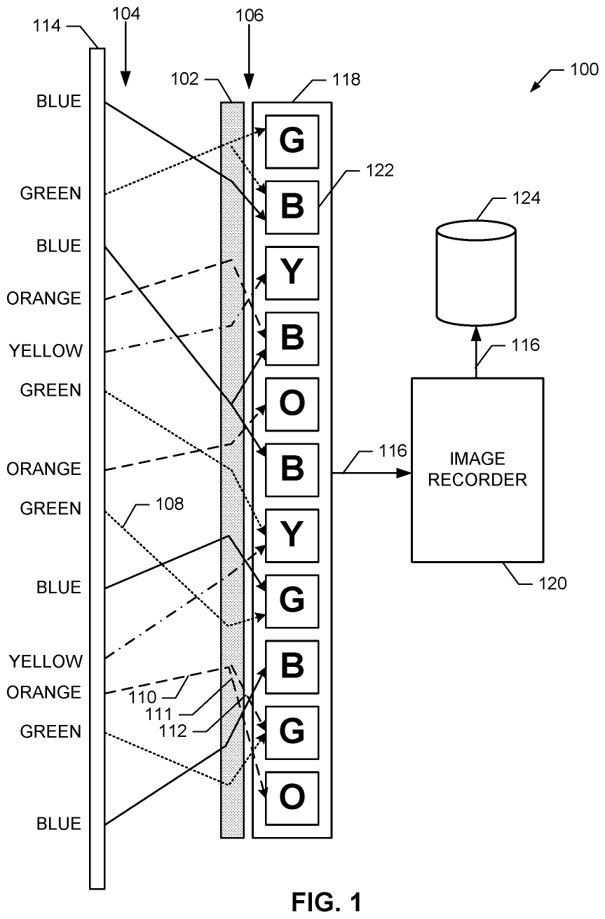

FIG. 1 is a block diagram of an example light field recording apparatus 100 constructed in accordance with the teachings of this disclosure for recording (e.g., capturing, etc.) images of light fields using an example optical mixing filter 102 (e.g., an optical member). The example optical mixing filter 102 of FIG. 1 randomly (e.g., pseudo-randomly) changes (e.g., distorts, mixes, etc.) the direction of light, as light passes through the example optical mixing filter 102. In some examples, reference is made to pseudo-random, which is a practical, often man-made equivalent of a random device, process, patterns, surfaces, etc. In examples disclosed herein, the use of pseudo-random devices, processes, etc. are sufficiently similar to their random equivalents so as to have a negligible effect on performance, characteristics, etc. Moreover, because a random optical mixing filter 102 can statistically have nearly identical distortions in close proximity, it may be preferable to use a pseudo-random mixing filter 102 to avoid such losses of resolution.

In some examples, the optical mixing filter 102 includes a pseudo-random, irregular optical structure having a plurality of pseudo-random optically different surfaces. In some examples, the surfaces have pseudo-random optical variations (e.g., in location, size, shape, angle, texture, etc.). Because the surfaces have pseudo-random optical variations, incoming light is pseudo-randomly distorted (e.g., refracted, reflected, mixed, etc.) as it passes through the optical structure into pseudo-random directions (e.g., one, two, etc.). The distortion(s) depends on where the incoming light is incident on the optical mixing filter 102, and/or at what angle. In some examples, the optical structure is partially pseudo-random, having a portion that has a simple or complex regular structure. In some examples, the optical structure has a substantially regular structure, which may be simple and/or complex.

In the illustrated example of FIG. 1, an optical input 104 (e.g., a light field, a light field signal, an optical signal, a 3D image, etc.) entering the example optical mixing filter 102 is pseudo-randomly distorted by the optical mixing filter 102, as it passes through the optical mixing filter 102 to form a pseudo-randomly distorted (e.g., mixed) optical output 106 (e.g., a light field, a light field signal, an optical signal, a 3D image, etc.). This is depicted in FIG. 1 as pseudo-random changes in incoming light rays of the optical input 104. For example, an example incoming green light ray 108 has its direction pseudo-randomly changed, an example incoming orange light ray 110 is pseudo-randomly split into two light rays 111 and 112 of different directions, etc. In some examples, the optical mixing filter 102 includes a transparent material (e.g., plastic, glass, etc.) having a high-resolution, spatially-uneven surface. In some examples, high-resolution refers to the number of received light directions relative to the number of pixels used to capture and display images. An example high-resolution surface has one light beam coming from/going to one pixel in a (direction)1:1(pixel) mapping. In some examples, the direction to pixel mapping ratio may be higher or lower than 1:1. In some examples, light beams coming from/going to more than one direction create interference (direction)N:1(pixel), reducing image quality and adding a shadow effect to the 3D image. More than one pixel being combined to a single light beam direction may reduce display/sensor resolution (direction)1:M(pixels). In some examples, the optical mixing filter 102 has, additionally and/or alternatively, pseudo-random uneven thicknesses. However, the unevenness can be partially ordered (e.g., not random, not pseudo-random, etc.), when there is at least one frustum surface per desired viewing angle. In some examples, diffusion in the example optical mixing filter 102 is controlled (e.g., reduced, managed, etc.) to maintain image quality. In some examples, the optical mixing filter 102 includes a sheet of randomly textured plastic material.

In some examples, the example optical input 104 is created by, for example, an example display device 114. The example display device 114 may be implemented using any number and/or type(s) of display device, such as those used in a smartphone, a tablet, a notebook computer, a monitor, a television, a projector, etc.

To capture an image 116 of the optical output 106, the example recording apparatus 100 includes an example image sensor 118, and an example image recorder 120. The example image sensor 118 of FIG. 1 captures the image 116 using a 2D array of sensor pixels, one of which is designated at reference numeral 122. The image sensor 118 may be implemented using any type of image sensor, such as those used in digital cameras. The image 116 captured by the example image sensor 118 is stored by the example image recorder 120 of FIG. 1 in a datastore 124. Images may be stored in the example datastore 124 using any number of data structures (e.g., a jpeg file, an mp4 file, etc.) suitable for storing still and/or moving images.

When the recording apparatus 100 is used to capture an image 116 of an optical input 104, the optical input 104 includes a plurality of light rays of different colors travelling in a plurality of directions in a region in space. Through its pseudo-random optical variations, the example optical mixing filter 102 pseudo-randomly distorts the directions of the light rays onto the 2D array of pixels 122 of the image sensor 118. The example recording apparatus 100 of FIG. 1 captures (e.g., records, etc.) the light field as a 2D image 116 captured using a 2D image sensor 118.

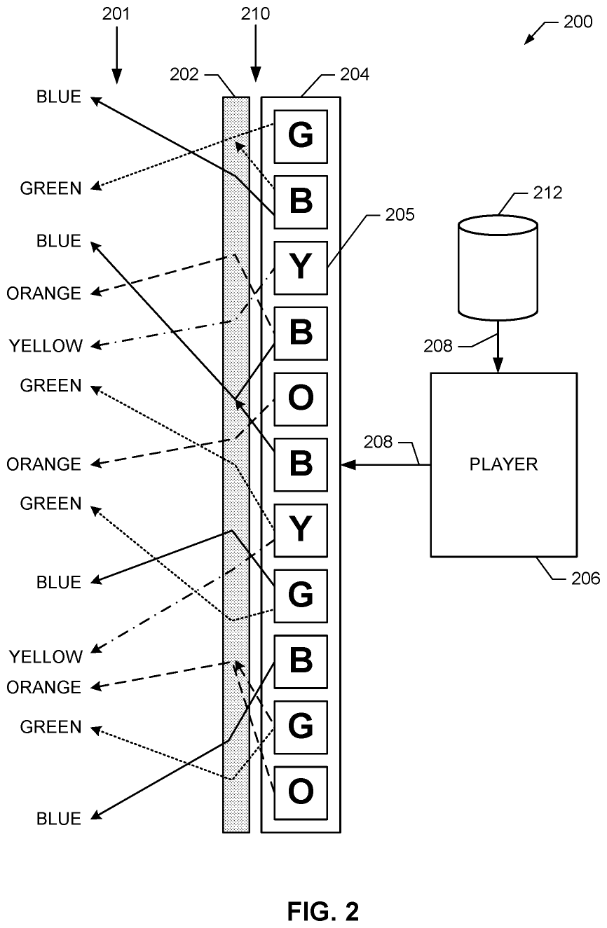

FIG. 2 is a block diagram of an example playback apparatus 200 constructed in accordance with teachings of this disclosure to create an optical output 201 (e.g., a light field, a light field signal, an optical signal, a 3D image, etc.) from a 2D image using an example optical member 202 (e.g., a mixing filter). In some examples, the playback apparatus 200 plays back a 2D image recorded using, for example, the example recording apparatus 100 of FIG. 1 (e.g., the example 2D image 116). To playback images (e.g., the example 2D image 116), the example playback apparatus 200 of FIG. 2 includes the example optical mixing filter 202, an example 2D display device 204, and an example player 206. The example 2D display device 204 of FIG. 2 displays images using a 2D array of display pixels, one of which is designated at reference numeral 205, that convert an image 208 provided by the player 206 into an optical output 210. The display device 203 may be implemented using any number and/or type(s) of display device, such as those used in a smartphone, a tablet, a notebook computer, a monitor, a television, a projector, etc. Images displayed by the example display device 204 are retrieved by the example player 206 from an example datastore 212. In some examples, the optical mixing filter 202 is added to (e.g., affixed to, secured to, mounted to, etc.) a display device 204 (e.g., a television, monitor, etc.) during manufacture, after manufacture, after installation of the display device 204, etc.

When the example playback apparatus 200 of FIG. 2 is playing back the optical output 201 (e.g., a light field, a light field signal, an optical signal, a 3D image, etc.), the player 206 retrieves a corresponding 2D image 208 (e.g., recorded using the example recording apparatus 100 of FIG. 1) from the example datastore 212, and provide the 2D image 208 to the display device 204 for playback. The display device 204 converts the 2D image 208 into the output optical 210.

Through its pseudo-random optical variations, the example optical mixing filter 202 randomly distorts (e.g., mixes, etc.) the optical output 210 of the display device 203 to form the optical output 201. In some examples, the optical mixing filter 201 of FIG. 2 is the optical mixing filter 102, or is substantially optically the same as the optical mixing filter 102 of FIG. 1, and has surfaces that properly diverge light for human viewing. In such examples, because light is being passed through the optical mixing filter 201 in the opposite direction (e.g., right-to-left in FIG. 2) that it was in FIG. 1 (e.g., left-to-right in FIG. 1), the pseudo-random optical mixing (e.g., distortion, etc.) performed by the optical mixing filter 201 is substantially opposite the pseudo-random optical mixing (e.g., distortion, etc.) performed by the optical mixing filter 102 in FIG. 1. In such circumstances, the optical mixing filter 201 undoes the distortion applied by the optical mixing filter 102. The optical mixing filters 102 and 201 enable the capture of an aggregate interference pattern of incoming optical signal (e.g., the optical input 104) by the 2D image sensor 118, and reproduction of the recorded or transmitted 2D patterns back into a 3D optical signal (e.g., the optical output 212), thus creating a 3D image (auto-stereoscopic) which can be viewed from multiple angles without glasses. In such circumstances, except for differences, such as quantization, compression, etc., the optical output 212 is equivalent to the original 3D image represented by the optical input 104. That is, together, the recording apparatus 90 and the playback apparatus 200 can be used to record and playback 3D images using 2D image capture and storage.

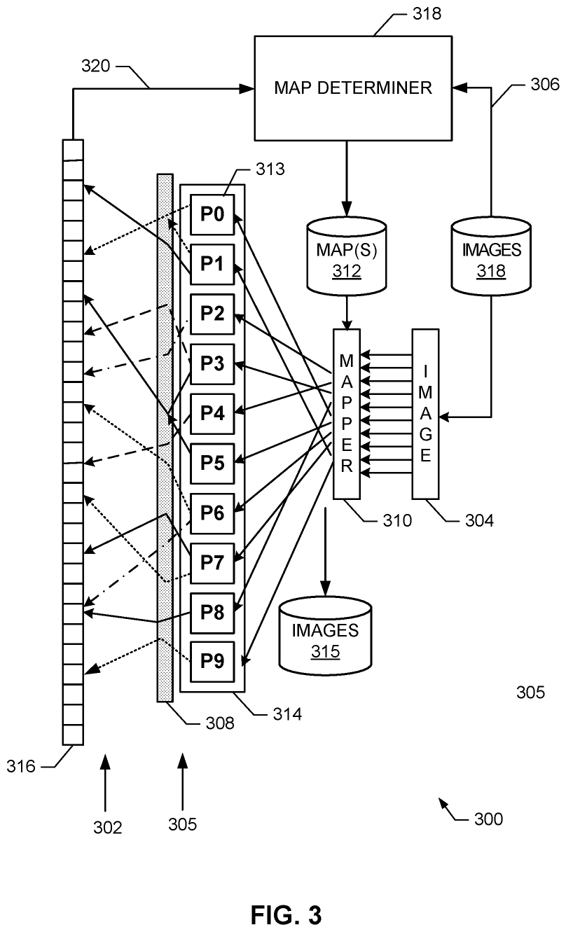

If the optical mixing filter 210 does/would not properly diverge light for human viewing, calibration for the playback apparatus 200 can be implemented. For example, a mapper 310 (FIG. 3) can be used to calibrate the playback apparatus 200 for the optical mixing filter 210.

In some examples, the image sensor 118 and the display device 203 are implemented by the same device (e.g., a device that can record and display images), and/or implemented in conjunction with the same optical mixing filter 102, 202. In such examples, the recording apparatus 100 and the playback apparatus 200 can be combined to form an apparatus that can record and playback 3D images based on 2D image capture, storage and playback.

Compared to known solutions, the examples of FIGS. 1 and 2 (and those described below) do not require glasses or other peripherals be worn or used by a user to present a light field, a 3D image, etc. from the display device 203. Further, they can generate optical outputs that can be displayed at multiple viewing angles, which is particularly beneficial for digital signage displays and large audiences.

FIG. 3 is a block diagram of an example system 300 that can be used to train an apparatus to recreate an optical image 302 (e.g., a light field, a light field signal, an optical signal, a 3D image, etc.) from a 2D image 304. The example 2D image 304 is recorded of an optical input 306 using, for example the example recording apparatus 100 of FIG. 1, When the example system 300 includes an example optical mixing filter 308 that is not the same as the optical mixing filter (e.g., the example optical mixing filter 102 of FIG. 1) used to record the image 304 of a light field (e.g., the example light field 104 of FIG. 1), the light field that would be created from the image 304 is not recognizable as the light field 306. To render the optical output 302 recognizable as the example light field 306, the example apparatus 300 includes an example mapper 310. The example mapper 310 of FIG. 3 uses an example map 312 to transform (e.g., distort) the image 304 by mapping elements of the image 304 to pixels (one of which is designated at reference numeral 313) of a display device 314. An example map 312 includes a plurality of entries that indicate that an element (x1, y1) of the image 304 is to be mapped to pixel (x2, y2) of the display device 314. In some examples, the mapping of element (x1, y1) of the image 304 to pixel (x2, y2) of the display device 314 includes a scale factor. In some examples, an input pixel (x2, y2) of the display device 314 includes, possibly scaled, inputs from more than one element of the image 304. In some examples, outputs of the mapper 310 are stored in an example images datastore 315 for later retrieval and playback.

To train the map 310, the example apparatus 300 of FIG. 1 includes an example sensor 316 and an example map determiner 318. The example sensor 316 of FIG. 3 is to capture (e.g., record, etc.) the optical output 302. The example image sensor 316 of FIG. 3 may be implemented using any type of image sensor, such as those used in digital cameras. In some examples, the sensor 316 is placed at other locations, allowing, for example, the optical output 302 to be formed for different orientations, locations, angles, etc.

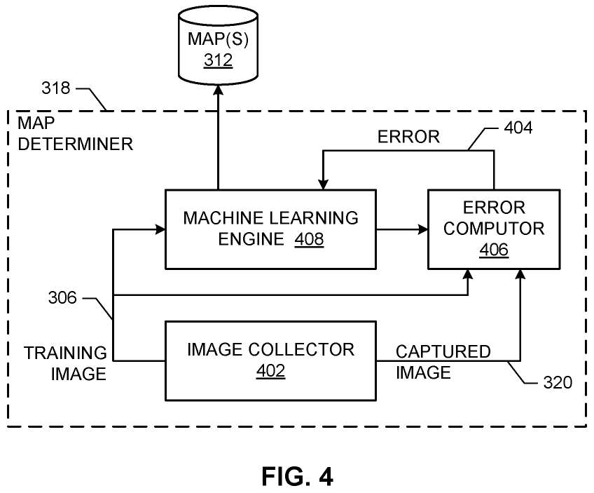

The example map determiner 318 of FIG. 3 determines (e.g., adjusts, adapts, trains, calibrates, etc.) the map 312 to reduce differences between an image 320 captured by the sensor 312, and the light field 306 of which the image 304 was recorded (see FIG. 1). In some examples, a plurality of light fields 306 and their corresponding 2D images 304 are used to determine a map 312. Example light fields 306 include, but are not limited to, high contrast images having a distinct pattern, such as a checkerboard pattern. In some examples, the example map determiner 318 uses machine learning to determine the map 312. Conceptually, the map 312 learned by the map determiner 318 pre-distorts the optical output 305 with a distortion that is substantially the opposite of the distortion that the optical mixing filter 308 will subsequently apply. Because, the optical distortion applied by the optical mixing filter 308 varies from location to location, a map 312 can be determined for different locations (e.g., a possible location, a supported location, etc.). An example implementation of the example map determiner 318 is discussed below relating to FIG. 4. By placing the sensor 316 at different locations, maps 312 for use in displaying images at separate locations where one wants to observe images can be determined. In some examples in which the optical mixing filter 308 comes pre-installed to a display device (e.g., a television, a computer monitor, etc.), the display device may come preinstalled from the factory with the map(s) 312, obviating the need for a user to perform training, calibration, etc.

To allow a playback apparatus (e.g., the example playback apparatus 200 of FIG. 2) to recreate optical outputs (e.g., light fields, 3D images, etc.) from recorded 2D images (e.g., the example image 116 of FIG. 1) recorded by different recording apparatus (e.g., the example recording apparatus 100 of FIG. 1), the recording apparatus can be calibrated. In some examples, a mapper similar to the example mapper 310 transforms the images 116 recorded by different recording apparatus so they are substantially similar. In some examples, the mapper is implemented between the sensor 118 and the image recorder 120, with the output of the mapper forming the image 116. Starting with a master recording apparatus, which does not need to implement a mapper, calibration target images 116 are captured for a set of calibration optical inputs 104. Subsequent recording apparatus train (e.g., adapt, determine, adjust, etc.) the map used by their mapper using the same calibration optical inputs 104 until substantially the calibration target images 116 are obtained. In some examples, the master recording apparatus includes a mapper to generate calibration target images 116 that have beneficial optical properties, such as even light distribution, even color distribution, etc.

FIG. 4 is a block diagram of an example implementation of the example map determiner 318 of FIG. 3. To collect images, the example map determiner 318 of FIG. 4 includes an example image collector 402. For each training iteration, the example image collector 402 collects the image 320 (FIG. 3) of the optical output 302 for a displayed image 304, and obtains from the images datastore 318 the optical output 306 (FIG. 3) captured in the example image 304 (see FIG. 1).

In the illustrated example of FIG. 4, the example map determiner 318 uses supervised machine learning. To compute an error 404 for use during machine learning, the example map determiner 314 includes an example error computer 406. The example error computer 406 of FIG. 4 computes an error between an expected output, which in the example of FIG. 4 is the light field 306, and the actual output, which in the example of FIG. 4 is the image 310. Any known or future number and/or type(s) of method(s), algorithm(s), calculation(s), etc. may be used to compute the error 404. In some examples, differences between the numbers of red pixels, blue pixels and green pixels in the output image 320 and the numbers of red pixels, blue pixels and green pixels in the light field 306 are computed to compute an error. In some examples, metrics such as mean squared error are used to compute an error.

To determine the map(s) 312, the example map determiner 318 of FIG. 4 includes an example machine learning engine 408. In some examples, the example machine learning engine 408 is any known or future neural network. In general, a neural network is a fully or partially interconnected network or mesh of nodes. In some examples, the connections between nodes have associated coefficients that represent the influence that the output of one node has on another. In some examples, the coefficients are trained or learned during a training or learning phase. In some examples, supervised learning where known inputs and outputs are known is used. In the illustrated examples, coefficients of the machine learning engine 408 represent the contents of the map(s) 312. The machine learning engine 408 may be trained, updated, etc. using any number of known or future method(s), architectures, node arrangements, etc.

In some examples, the map used by the mapper of a recording apparatus can be determined (e.g., adapted, adjusted, calibrated, etc.) using the example map determiner 318. In some such examples, the training image(s) 306 of FIG. 4 are image(s) 116 recorded by a master recording apparatus, and the captured image(s) 320 of FIG. 4 are image(s) 116 recorded by the recording apparatus being calibrated.

While an example manner of implementing the map determiner 318 of FIG. 3 is illustrated in FIG. 4, the elements, processes and/or devices illustrated in FIG. 4 may be combined, divided, re-arranged, omitted, eliminated and/or implemented in any other way. Further, the example image collector 402, the example error computer 406, the example machine learning engine 408 and/or, more generally, the example map determiner 318 of FIG. 3 may be implemented by hardware, software, firmware and/or any combination of hardware, software and/or firmware. Thus, for example, any of the example image collector 402, the example error computer 406, the example machine learning engine 408 and/or, more generally, the example map determiner 318 could be implemented by analog or digital circuit(s), logic circuits, programmable processor(s), programmable controller(s), graphics processing unit(s) (GPU(s)), digital processor(s) (DSP(s)), application specific integrated circuit(s) (ASIC(s)), programmable logic device(s) (PLD(s)), field programmable gate array(s) (FPGA(s)), and/or field programmable logic device(s) (FPLD(s)). When reading any of the apparatus or system claims of this patent to cover a purely software and/or firmware implementation, at least one of the example image collector 402, the example error computer 406, and/or the example machine learning engine 408 is/are hereby expressly defined to include a non-transitory computer-readable storage device or storage disk such as a memory, a digital versatile disk (DVD), a compact disk (CD), a Blu-ray disk, etc. including the software and/or firmware. Further still, the example map determiner 318 of FIG. 3 may include elements, processes and/or devices in addition to, or instead of, those illustrated in FIG. 3, and/or may include more than one of any or all the illustrated elements, processes and devices.

While example manners of implementing the example recording apparatus 100, the example playback apparatus 200, and the example training apparatus 300 are shown in FIGS. 1, 2, and 3, the elements, processes and/or devices illustrated in FIGS. 1, 2, and 3 may be combined, divided, re-arranged, omitted, eliminated and/or implemented in any other way. Further still, the example recording apparatus 100, the example playback apparatus 200, and the example training apparatus 300 are shown in FIGS. 1, 2, and 3 may include elements, processes and/or devices in addition to, or instead of, those illustrated, and/or may include more than one of any or all the illustrated elements, processes and devices.

The example image recorder 120, the example player 206, and the example mapper 310 may be implemented by hardware, software, firmware and/or any combination of hardware, software and/or firmware. Thus, for example, any of the example image recorder 120, the example player 206, and/or the example mapper 310, could be implemented by analog or digital circuit(s), logic circuits, programmable processor(s), programmable controller(s), GPU(s), DSP(s), ASIC(s), PLD(s), FPGA(s), and/or FPLD(s). When reading any of the apparatus or system claims of this patent to cover a purely software and/or firmware implementation, at least one of the example image recorder 120, the example player 206, and/or the example mapper 310 is/are hereby expressly defined to include a non-transitory computer-readable storage device or storage disk such as a memory, a DVD, a CD, a Blu-ray disk, etc. including the software and/or firmware.

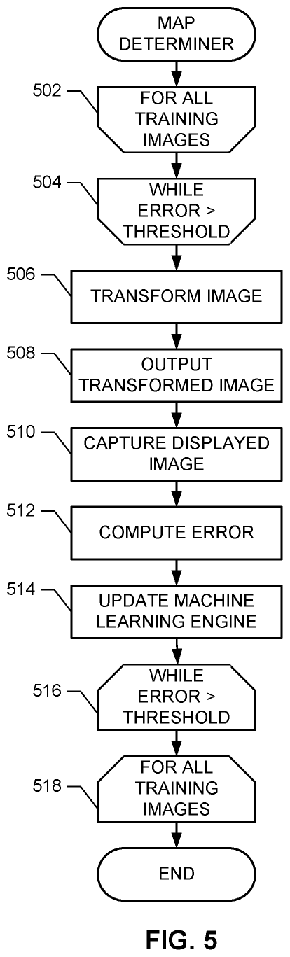

A flowchart representative of example computer-readable instructions for implementing the map determiner 314 of FIGS. 3 and 4 is shown in FIG. 5. In this example, the computer-readable instructions implement a program for execution by a processor, such as the processor 910 shown in the example processor platform 900 discussed below in connection with FIG. 9. The program may be embodied in software stored on a non-transitory computer-readable storage medium such as a CD, a floppy disk, a hard drive, a DVD, a Blu-ray disk, or a memory associated with the processor 910, but the entire program and/or parts thereof could alternatively be executed by a device other than the processor 910 and/or embodied in firmware or dedicated hardware. Further, although the example program is described with reference to the flowchart illustrated in FIG. 8, many other methods of implementing the example map determiner 314 may alternatively be used. For example, the order of execution of the blocks may be changed, and/or some of the blocks described may be changed, eliminated, or combined. Additionally, and/or alternatively, any or all the blocks may be implemented by hardware circuits (e.g., discrete and/or integrated analog and/or digital circuitry, an FPGA, a PLD, a FPLD, an ASIC, a comparator, an operational-amplifier (op-amp), a logic circuit, etc.) structured to perform the corresponding operation without executing software or firmware.

As mentioned above, the example processes of FIG. 5 may be implemented using coded instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer-readable medium is expressly defined to include any type of computer readable storage device and/or storage disk and to exclude propagating signals and to exclude transmission media.

For all training images 304 captured for a light field 306 (FIG. 3) (block 502), and while the error 404 computed by the error computer 406 exceeds a threshold (block 504), the mapper 310 uses a current map 312 to transform each training image 304 into pixels of the display device 206 (block 506). The display device 308 outputs an optical output 305 corresponding to the transformed training image, and the optical mixing filter 308 distorts the optical output 305 forming a distorted optical output 302 (block 508). The sensor 316 captures an image 320 corresponding to the distorted optical output 302 of the optical mixing filter 308 (block 510). The example error computer 406 computes an error 404 between the light field 306 corresponding to the training image 304 and the image 320 (block 512), and the machine learning engine 408 is updated using the error (514). When all training images 304 have been used (block 502), and/or when the error 404 computed by error computer 406 no longer exceeds the threshold (block 504), control exits from the example program of FIG. 5. In some examples, training images may be applied multiple times.

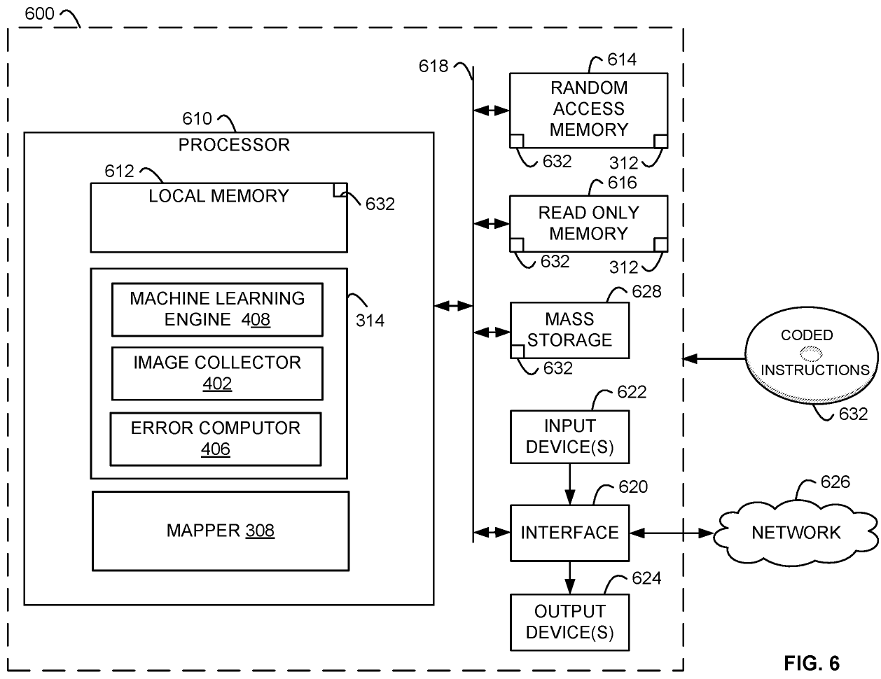

FIG. 6 is a block diagram of an example processor platform 600 capable of executing the instructions of FIG. 5 to implement the example map determiner 318 of FIG. 3 and FIG. 4. The processor platform 600 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 600 of the illustrated example includes a processor 610. The processor 610 of the illustrated example is hardware. For example, the processor 610 can be implemented by integrated circuits, logic circuits, microprocessors, GPUs, DSPs or controllers from any desired family or manufacturer. The hardware processor may be a semiconductor based (e.g., silicon based) device. In this example, the processor 610 implements the example map determiner 314, the example image collector 402, the example error computer 406, the example machine learning engine 408, and the example mapper 308.

The processor 610 of the illustrated example includes a local memory 612 (e.g., a cache). The processor 610 of the illustrated example is in communication with a main memory including a volatile memory 614 and a non-volatile memory 616 via a bus 618. The volatile memory 614 may be implemented by Synchronous Dynamic Random-Access Memory (SDRAM), Dynamic Random-Access Memory (DRAM), RAMBUS® Dynamic Random-Access Memory (RDRAM®) and/or any other type of random access memory device. The non-volatile memory 616 may be implemented by flash memory and/or any other desired type of memory device. Access to the main memory 614, 616 is controlled by a memory controller. In this example, the main memory 614, 616 implements the example map(s) 312, and the datastores 124, 212 and 318.

The processor platform 600 of the illustrated example also includes an interface circuit 620. In the illustrated example, input devices 622 are connected to the interface circuit 620. In this example, the input devices(s) 622 implement the example sensors 118 and 316. The example input devices 622 permit(s) a user to enter data and/or commands into the processor 610. The input device(s) 622 can be implemented by, for example, a keyboard, a mouse, a touchscreen.

Output devices 624 are also connected to the interface circuit 620 of the illustrated example. In the illustrated example, the example output device(s) 620 implement the example display devices 204 and 314. The output devices 624 can be implemented, for example, by display devices (e.g., a light emitting diode (LED), an organic light emitting diode (OLED), a liquid crystal display, a cathode ray tube display (CRT), a touchscreen, etc.) a tactile output device, a printer and/or a speaker.

The processor platform 600 of the illustrated example also includes mass storage devices 628 for storing software and/or data. Examples of such mass storage devices 628 include floppy disk drives, hard drive disks, CD drives, Blu-ray disk drives, redundant array of independent disks (RAID) systems, and DVD drives.

Coded instructions 632 including the coded instructions of FIG. 5 may be stored in the mass storage device 628, in the volatile memory 614, in the non-volatile memory 616, and/or on a removable non-transitory computer-readable storage medium such as a CD or DVD.

“Including” and “comprising” (and all forms and tenses thereof) are used herein to be open ended terms. Thus, whenever a claim recites anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended. Conjunctions such as “and,” “or,” and “and/or” are inclusive unless the context clearly dictates otherwise. For example, “A and/or B” includes A alone, B alone, and A with B. In this specification and the appended claims, the singular forms “a,” “an” and “the” do not exclude the plural reference unless the context clearly dictates otherwise.

Any references, including publications, patent applications, and patents, cited herein are hereby incorporated by reference to the same extent as if each reference were individually and specifically indicated to be incorporated by reference and were set forth in its entirety herein.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus, comprising:
a mapper to transform a first image into a second image based on a first map;
a display device to output the second image as a first optical output; and
a first optical member to pseudo-randomly distort at least a first portion of the first optical output to form a first light field.

2. The apparatus of claim 1, wherein the first optical member includes a regularly arranged portion to distort at least a second portion of the first optical output.

3. The apparatus of claim 1, wherein the first optical member pseudo-randomly changes direction of light as light passes through the first optical member.

4. The apparatus of claim 1, wherein the first optical member includes at least one of a pseudo-random irregular optical structure, a pseudo-random irregular surface, or a pseudo-random irregular thickness.

5. The apparatus of claim 1, wherein the first image represents a second light field pseudo-randomly distorted by a second optical member.

6. The apparatus of claim 1, wherein the mapper maps pixels of the first image to pixels of the second image.

7. The apparatus of claim 1, further including:
a sensor to capture a second image representative of the first light field; and
a machine learning engine to adjust the first map to reduce a difference between the second image and a second light field used to record the first image.

8. A method, comprising:
receiving a first optical output representing a distorted version of a first image, the first image representing a first optical input pseudo-randomly distorted by an optical member;
pseudo-randomly distorting the first optical output to form a third optical output, wherein the third optical output corresponds to the first optical input; and
presenting the third optical output.

9. The method of claim 8, further including:
capturing a second image representing the third optical output; and
determining a map based on the second optical input and the second image.

10. The method of claim 9, wherein determining the map by includes executing a neural network to adjust the map to reduce a difference between the second optical input and the second image.

11. The method of claim 9, further including distorting a third image using the map to form the distorted version of the first image.

12. The method of claim 8, wherein pseudo-randomly distorting the first optical output to form the third optical output includes passing the first optical output through an optical member that pseudo-randomly changes direction of light as light passes through the optical member.

13. A non-transitory computer-readable storage medium comprising instructions that, when executed, cause a machine to perform at least the operations of:
pseudo-randomly optically distorting a first light field signal; and
recording a first image representing the distorted first light field signal that can be used to recreate the first light field signal using a pseudo-random optical distortion.

14. The non-transitory computer-readable storage medium of claim 13, wherein the operations further include:
distorting the first image to form a second image;
displaying the second image as an optical signal;
pseudo-randomly distorting the optical signal to form a second light field signal; and
presenting the second light field signal.

15. The non-transitory computer-readable storage medium of claim 13, wherein the operations further include:
transform the first image into a second image based on first map; and
adjusting the first map based on the first image and a calibration target image captured using a second pseudo-random distortion.
